(19) United States
(12) Patent Application Publication
(10) Pub. No.: US 2008/0150876 A1
(43) Pub. Date: Jun. 26, 2008

(54) Liquid crystal display with dynamic field emission device as backlight source thereof

(76) Inventor: Chih-Che Kuo, Taipei City (TW)

Correspondence Address: HDSL, 4331 STEVENS BATTLE LANE, FAIRFAX, VA, 22033, US

(21) Appl. No.: 11/548,755

(22) Filed: Oct. 12, 2006

(51) Int. Cl. G09G 3/36

(52) U.S. Cl. 345/102

(57) ABSTRACT

A liquid crystal display using dynamic emission device as backlight source includes a field emission device and a liquid crystal panel. The field emission device is divided into plural field emission sections formed as a chessboard. The surface of the field emission device is attached to the liquid crystal panel. Wherein, each field emission section is corresponded to each image-displaying section on the liquid crystal panel. According to the lightness variation of each image-displaying section, each field emission section dynamically compensates the lightness of each image-displaying section. Thereby, the objective of enhancing the dynamic range of the liquid crystal display is achieved.

### BACKGROUND OF THE INVENTION

1. Field of the Invention

The present invention relates to a liquid crystal display technology, in particular, to a liquid crystal display technology using field emission device as backlight source.

1. Description of Prior Art

Accordingly, liquid crystal display (LCD) not only can generate colorful image of high resolution, but also can be widely applied to various electronic display devices, since it is thin, light and portable, power-saving, and without environmental problem.

But, because the liquid crystal material in common LCD can not emit light by itself, an external light source must be taken as backlight source. Wherein, two filters and one liquid crystal layer may be applied to modulate the backlight source uniformly. After being filtered by the first filter and being refracted by the liquid crystal molecule, light passes through liquid crystal layer, then after being filtered by the second filter, the light is emitted out of backlight source. However, liquid crystal displaying panel is not made of material that is totally transparent, so its transmittance is usually between 3%˜8% around. Even when pixel is completely switched to illumination, its light is still absorbed in most part. Since most light is absorbed and can not pass through panel, so the lightness of pixel is insufficient. On the other hand, when pixel is switched to complete darkness, light leaks and emits out of panel, because the electrode controlling the rotation of liquid crystal can not be closed completely. Thereby, pixel can't be situated in total darkness, so its shadow contrast is insufficient. This is the so-called “low dynamic range” phenomenon of LCD. In here, dynamic range is defined as the ratio between highest lightness and lowest lightness. When the ratio is large (i.e., within high dynamic range), it means that the LCD's shadow contrast ratio is high. If this ratio is small (i.e., within low dynamic range), it means that the LCD's shadow contrast ratio is low. Common LCD is restrained by its low dynamic range, so its quality performance of screen picture can not reach ideal requirement in some high level applications. Dynamic range is one important factor that relates to the picture quality of LCD. In order to promote LCD's dynamic range, there are two kinds of common techniques: the first one is the improvement of the structure and material of liquid crystal panel, and the other one is to improve the design of backlight source. However, the effect of improving the liquid crystal material is quite limited, and its technique level and expenditure cost are high as well. Relatively, it is one effective and economic choice to promote the contrast ratio shown by the entire LCD directly through backlight source, so a concept of LCD with high dynamic range is conceived. The so-called “LCD with high dynamic range” is to take liquid crystal panel as a filtering structure. For example, it is assumed that a LCD's dynamic range is c1:1. When a dynamic range of c2:1 backlight is used to compensate the LCD's dynamic range, the new LCD's dynamic range will be the multiplication of two values in theory, that is, (c1*c2):1.

Therefore, some dealers, according to aforementioned concepts, propose plural light emission diodes (LEDs) formed as chessboard for the backlight source of LCD, through dynamic compensation to reach the effect of enhancing the dynamic range of LCD. However, corresponding to the increasing size of panel, the area of backlight board is increased, so is the quantity of LED. Furthermore, since the manufacturing method of LED is difficult, the manufacturing cost is increased significantly. In the meantime, if the quantity of LED is increased abruptly, it is further difficult to solve the problem of high heat dissipation thereof. Accordingly, the problem desired to be solved by the dealer is how to effectively replace the structure of LED to make LCD have the effect of high dynamic range.

### SUMMARY OF THE INVENTION

With respect to above shortcomings, the present invention is to provide a LCD with dynamic field emission device as backlight source thereof Wherein, the dynamic field emission device is made through a mass production of semiconductor process. Not only the manufacture is convenient and cheap, but also its heat dissipation effect is far better than that of LED.

The present invention proposes a preferable embodiment, wherein a dynamic field emission device is used as the backlight source of LCD, which is comprised of a field emission device that is divided into plural field emission sections formed as chessboard. The surface of the field emission device is attached to a liquid crystal panel, wherein each field emission section is corresponded to each image-displaying section on the liquid crystal panel. According to the lightness variation of each image-displaying section, each field emission section dynamically compensates the lightness of each image-displaying section, in order to reach the objective of enhancing the dynamic range of LCD.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is an illustration showing the structure of a field emission backlight source for LCD according to the present invention;

FIG. 2 is an enlarging illustration showing the corresponding relationship between the field emission section and image-displaying section according to the present invention;

FIG. 3 is an enlarging illustration showing the corresponding relationship between the field emission section and image-displaying section in another preferable embodiment according to the present invention;

FIG. 4 is an enlarging illustration showing the corresponding relationship between the field emission section and image-displaying section in further preferable embodiment according to the present invention; and

FIG. 5 is an illustration showing a field emission backlight source and its controlling-and-driving circuit according to the present invention.

### DETAILED DESCRIPTION OF THE INVENTION

In cooperation with attached drawings, the technical contents and detailed description of the present invention will be as follows.

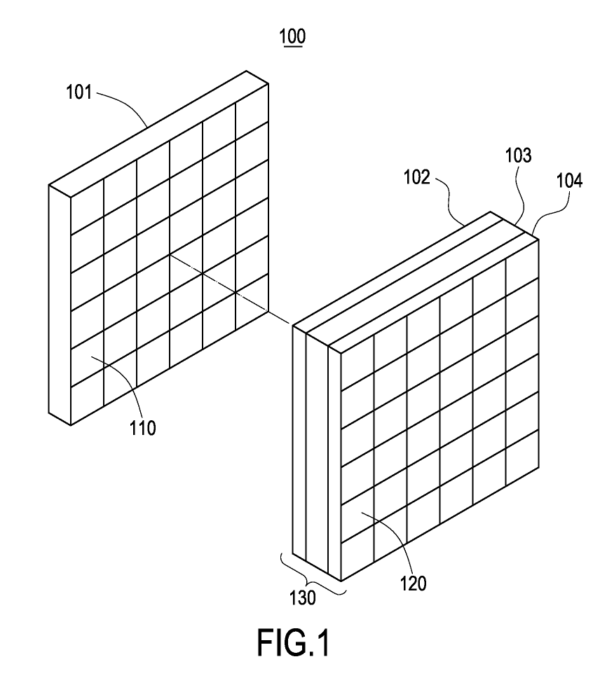

Please refer to FIG. 1, which shows a field emission device 101 for the backlight source of a LCD 100. The LCD 100 includes a field emission device 101 and a liquid crystal panel 130. Wherein, the field emission device 101 is divided into plural field emission sections formed as chessboard. Each field emission section is a single white light emitting section, which may be manufactured by semiconductor process. The field emission device 101 may also be divided by the control of software or hardware, in order to form plural field emission sections structured as chessboard. The lightness variation of each field emission section may be controlled independently to compensate the dynamic range of LCD 100 according to different lightness of each field emission section. One side of the field emission device 101 is attached to the liquid crystal panel 130, which includes a liquid crystal layer 103, a first filter 102, and a second filter 104. In parallel with each other, these two filters 102 and 104 are respectively attached to the two surfaces of the liquid crystal layer 103. Taking the field emission section 110 on field emission device 101 as an example, the light waves emitted out are polarized in different planes, but only one light wave that is parallel to the optic axis of first filter 102 may pass through the first filter 102. Furthermore, there is one specific angle existing between the optic axes of first filter 102 and second filter 104 of the liquid crystal panel 130, such that there is no light transmitted out. On the other hand, by the rotation of liquid crystal molecule in the liquid crystal layer 103, the light wave is refracted to make its polarized plane aligned with the optic axis of second filter 104, so the transmission of light through liquid crystal panel 130 may be controlled. In the meantime, the field emission section 110 is made to correspond to the image-displaying section 120 on the image-displaying surface of the liquid crystal panel 130. So, it is possible that each field emission section may be corresponded to each image-displaying section on the image-displaying surface of liquid crystal panel 130. In other words, each field emission section 110 is specifically responsible for the backlight illumination of its corresponding image-displaying section 120. When the lightness of an image-displaying section 120 is higher, its corresponding field emission section 110 is then made to provide a higher lightness of backlight. When the lightness of an image-displaying section 120 is lower, its corresponding field emission section 110 is then made to provide a lower lightness of backlight. Thereby, there is a higher contrast ratio existing among every image-displaying section.

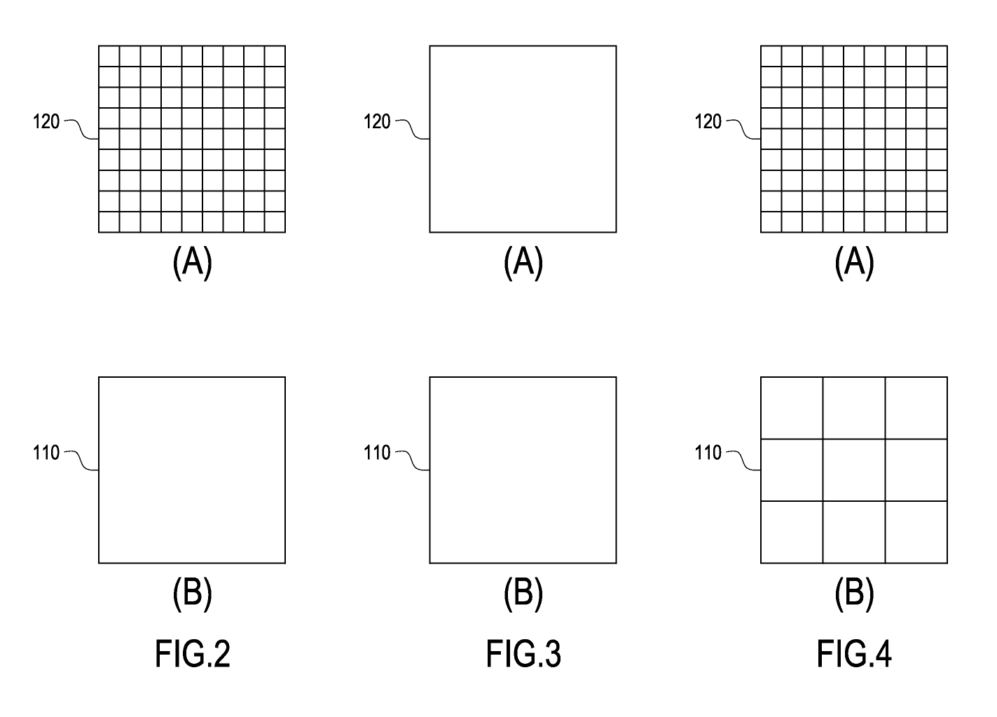

Please refer to FIG. 2 continuously. It shows an enlarging illustration of the corresponding relationship between the field emission section 110 and the image-displaying section 120 (it can be analogous to the corresponding relationship between each field emission section and each image-displaying section), wherein FIG. 2(A) and FIG. 2(B) belong to one preferable embodiment. The field emission section 110 in FIG. 2(B) is a field emission unit (i.e., a pair of anode and cathode) and is corresponded to the image-displaying section 120 in FIG. 2(A). The image-displaying section 120 includes plural pixels shown as a 9*9 chessboard in FIG. 2(A). The lightness of plural pixels is compensated by the light emitted from one field emission unit. Since each field emission unit situated on the field emission device 101 is controlled independently, the dynamic range of LCD may be enhanced by the difference of shadow contrast ratio among every field emission unit.

Please refer to FIG. 3 further, wherein A and B are enlarging illustrations respectively corresponding to the image-displaying section 120 and field emission section 110 according to another embodiment of the present invention. The field emission section 110 in FIG. 3(B) is comprised of a field emission unit (it is referred as a pair of anode and cathode), which is corresponded to the image-displaying section 120 in FIG. 3(A). The image-displaying section 120 is represented a single pixel, the lightness of each which is independently modulated by each corresponding field emission unit. Thereby, the dynamic range of LCD may be enhanced by the difference of shadow contrast ratio among every field emission unit.

Please refer to FIG. 4 continuously, which includes FIG. 4(A) and FIG. 4(B) that are enlarging illustrations corresponding to the image-displaying section 120 and field emission section 110 according to another preferable embodiment of the present invention. The field emission section 110 in FIG. 4(B) includes plural field emission units, the quantity of which may be different from or same as that of the pixels included in the corresponding image-displaying section 120. As shown in FIG. 4(B), the field emission section 110 includes plural field emission units formed as a 3*3 chessboard (it is referred as a pair of anode and cathode), the lightness of each which may be independently controlled by the field emission section 110, but each field emission unit in the field emission section 110 is all belong to one lightness, which is corresponded to that of the image-displaying section 120 in FIG. 4(A), which includes plural pixels formed as a 9*9 chessboard. The lightness of the plural pixels in the image-displaying section 120 is uniformly and commonly compensated by the plural field emission units formed as a 3*3 chessboard, while the lightness of each field emission section situated on the field emission device 101 may be modulated independently. The dynamic range of LCD may thereby be enhanced by the difference of shadow contrast ratio among every field emission section.

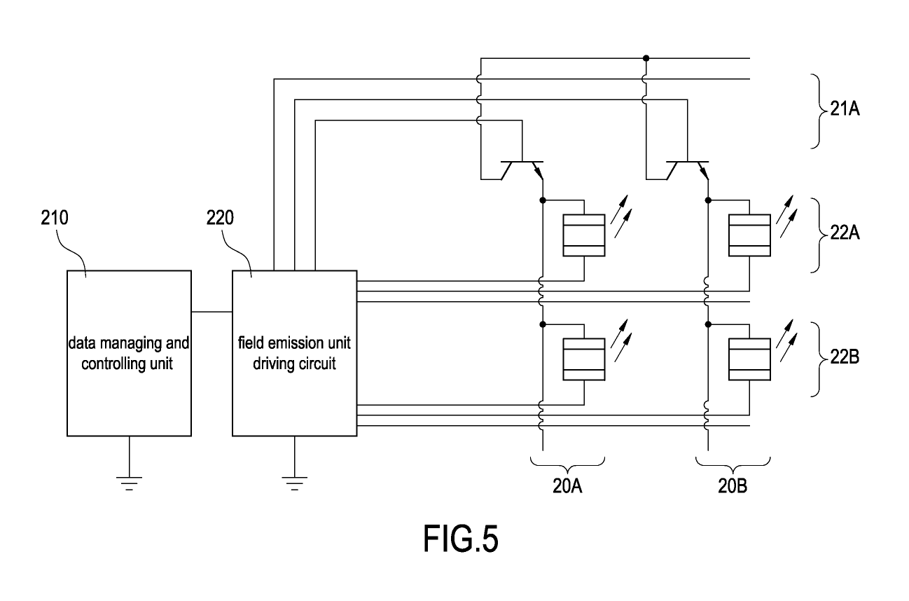

Please refer to FIG. 5, which shows a field emission device 101 and its controlling-and-driving circuit, wherein a data managing-and-controlling unit 210 is used to judge the lightness variation of each image-displaying section by transferring the dynamic modulating-and-compensating signals to a field emission unit driving circuit 220 in order to dynamically compensate the lightness of each image-displaying section. The field emission unit driving circuit 220 is electrically connected to the data managing-and-controlling unit 210 and controls the gate of each transistor in a transistor-choosing array 21A of each field emission unit, such that the switch of each transistor is thereby controlled. Furthermore, the anode of each field emission unit is electrically connected to the emitter of each transistor, while its cathode is electrically connected to the field emission unit driving circuit 220. In the meantime, each field emission unit may be arranged as array (22A, 22B) and column (20A, 20B) of a chessboard, and its structure may be a field emission structure of diode or triode. According to the compensating flowchart for dynamic range in this preferable embodiment, the data managing-and-controlling unit 210 decides the brightness of each image-displaying section and transfers the dynamic modulating-and-compensating signals to the field emission unit driving circuit 220, which controls the light quantity needed and emitted by each field emission section that is corresponded to each image-displaying section through the conducting intensity of each transistor in the transistor-choosing array 21A. Thereby, the objective of enhancing the dynamic range of a LCD is achieved.

Aforementioned structures are only preferable embodiments according to the present invention, being not used to limit its executing scope. Any equivalent variation and modification made according to appended claims is all covered by the claims claimed by the present invention.

What is claimed is:

1. A LCD with dynamic field emission device as backlight source thereof, including:
a field emission device, which is divided into plural field emission sections formed as a chessboard, each field emission section being able to control the lightness thereof,
a liquid crystal panel, which is attached to the field emission device, the light emitted from each field emission section being corresponded to plural image-displaying sections;
a data managing-and-controlling unit, which is electrically connected to each image-displaying section on the liquid crystal panel for judging the lightness of each image-displaying section, signals for compensating the dynamic range being generated according to the lightness variation of each image-displaying section; and
a field emission unit driving circuit, which is electrically connected to each field emission section and the data managing-and-controlling unit, and which receives the compensating signals for dynamic range in order to drive each field emission section corresponded to each image-displaying section, such that the lightness generated by each field emission section is different.

2. The LCD according to claim 1, wherein the field emission section is a single field emission unit.

3. The LCD according to claim 1, wherein the field emission section is comprised of plural field emission units.

4. The LCD according to claim 1, the image-displaying section is comprised of plural pixels.

5. The LCD according to claim 1, the image-displaying section is comprised of one single pixel.
